(19) United States
(12) Patent Application Publication
(10) Pub. No.: US 2004/0071623 A1
(43) Pub. Date: Apr. 15, 2004

(54) Synthetic diamonds prepared from roses

(76) Inventor: John N. Hatleberg, New York, NY (US)

Correspondence Address: WINSTON & STRAWN, PATENT DEPARTMENT, 1400 L STREET, N.W., WASHINGTON, DC, 20005-3502, US

(21) Appl. No.: 10/679,292

(22) Filed: Oct. 7, 2003

Related U.S. Application Data
(60) Provisional application No. 60/416,579, filed on Oct. 8, 2002.

(51) Int. Cl. C01B 31/00

(52) U.S. Cl. 423/414

(57) ABSTRACT

The present invention relates to a method of making a more permanent remembrance from a gift that includes organic material, wherein the gift has ephemeral beauty and symbolizes the feelings of a gift-giver toward a recipient. This method includes transforming the ephemeral beauty of the gift to a more permanent or eternal manifestation that symbolizes the feelings of the gift-giver toward the recipient. This result is conveniently achieved by converting the organic material of the gift to a synthetic diamond. The synthetic diamond can be prepared by transforming the organic material of the gift to a carbon or carbon-containing compound; and then converting the carbon or carbon-containing compound into the synthetic diamonds.

This application claims the benefit of U.S. provisional application No. 60/416,579 filed Oct. 8, 2002.

### BACKGROUND ART

The present invention relates to a method of making a remembrance from a gift that includes organic material by converting the organic material of the gift to a synthetic diamond. This enables one to transform the ephemeral beauty of the gift to a more permanent or everlasting manifestation that symbolizes both the beauty of the gift as well as the gift-giver's feelings towards the recipient. The synthetic diamonds can be made from carbon or a carbon-containing compound such as graphite that is obtained from the conversion of the organic material of the gift. Preferably, these diamonds are made from a flower, such as a rose, that is carbonized to provide the graphite material that is utilized to synthesize the diamond. In this way, a synthetic diamond is made from and represents a remembrance of the gift, and the recipient can enjoy it for a much longer time than the rose or flower. Also, as a gift of either flowers or diamonds symbolizes the love of the gift giver toward the recipient, the combination of these represents a more powerful statement of the gift-giver's feelings and love toward the recipient.

Diamonds and Love

Historically diamonds were very rare. India was the only large source of diamonds for most of the last two thousand years. Up until the 17th century any diamond weighing over ten carats was kept in India. In Europe during the Middle Ages all that was known about diamonds was that they came from India, that they were very rare and that they were unbelievable hard. It was not until 1379, during the reign of Charles V, that there is any record of any diamond in Europe at all.

It was the incredible hardness of a diamond and what that represented to the people of the time that gave rise to the legends ascribed to it. The word diamond arises from the Greek word “adamas” meaning unconquerable. Only rulers could own or wear diamonds and their magic powers were believed to make one invincible. To the amazement of mankind, diamonds were resistant to fire and harder than steel.

Diamonds slowly made their way to Europe. In 1400 Henry IV is the first king to be depicted wearing a diamond in a painting. Even though there were no diamonds to be had in Europe, they were believed to be so powerful that in the mid thirteenth century St. Louis established sumptuary laws forbidding women to wear them. Only the Virgin Mary and later the Queen were bequeathed the honor to take on the properties transferred from the gem. It was not until 1440 that Agnes Sorel, the beloved lesser nobility mistress of Charles VII, that women first wore diamonds. The beautiful Agnes persuaded the male members of court to loan her their diamonds and jewels. She then appeared before Charles in jeweled profusion to seduce him. So great was his desire for her that the established sumptuary laws were overturned. This caused a near revolution among the more socially prominent women at court and from that time on women had the right to wear diamonds, and diamonds of a secular as well as religious purpose.

It was under the House of Burgundy circa 1450 that modest numbers of diamonds finally made their way into the royal houses of Europe. Interestingly, as the presence of diamonds became a reality, numerous extraordinary superstitions concerning them were propagated by the masses who could never hope to own them. Whereas the Greeks, as relayed in the writings of Pliny, had a credible understanding of the qualities of the diamond, the masses of the Middle Ages granted them numerous incredible properties. These included preventing madness, warding off lightning and rendering its wearer invisible. The diamond was so valued that it must have mystical powers commensurate with its rarity.

The treasury of Charles the Bold included what was probably the famous “Florentine Diamond”, a dress sword embellished with diamonds and the Order of the Garter cast in gold and set with diamonds. When his daughter, Mary of Burgundy, was engaged to the Archduke Maximilian in 1477, the Archduke received a letter advising “At the betrothal, your Grace must have a ring set with a diamond and also a gold ring.” This is one of the first records of the gift of a diamond being given to seal an engagement. A contemporaneous record from the marriage of Constanzo Sforza and Camilla d'Aragona exists in a series of miniatures now at the Vatican. They depict the divinity Hymen, shown as a handsome youth wearing a garland of roses and a tunic festooned with the images of the diamond ring that would consecrate the marriage. Such events heralded a shift in the symbolism of a diamond. The strength and durability of a diamond had represented a ruler's invincibility. Those properties now became the perfect vehicle to convey the supreme strength, fidelity and devotion that characterize a marriage.

The Fountainbleau School of painters worked in a courtly manner during the second half of the sixteenth century. They painted depictions of opulence, decadence and wealth, eschewing the moralism of the previous century. Their patrons enjoyed stylish paintings of nudes, such as “A Woman at her Dressing Table.” In one such portrait the noblewoman is shown empowering her femininity by appearing solely attired in jewels. Such art expresses that in this less restricted period diamonds were encouraged gifts not only for matrimony but any occasion of romantic love.

A study of early diamond jewelry shows that only uncut diamond crystals were employed. Due to the hardness of the diamond it was not until the late fifteenth century that initial attempts at cutting them were achieved. From the fifteenth to the end of the seventeenth century the primary type of faceted diamond was the “Rose Cut”. This name arose from the similarity of the unfolding triangulation of facets to the initial opening of a rosebud. That both uncut and primitively cut diamonds had a ‘crude form’ may have contributed to the reliance on technically sophisticated jewelry settings to convey the symbolism of love. To begin, the ring itself, its eternity of circle, beautifully conveyed the everlasting quality of the marriage. Specifically, “gimmel”, or twin rings of the 16th century were formed in two halves. Only by their interlocking union, often representing the husband and wife, could the ring be worn. Similarly, “poesie rings”, which were the primary engagement ring of the period, were beautifully enameled settings decorated with hearts or roses and inscribed with love sentiments.

Diamonds were discovered in Brazil in the 1730's. A profusion of diamonds was discovered. Finally, diamonds were available in a supply sufficient to become the preferred jewel of the upper classes. Improvements in candle lighting and the rise of evening parties brought out the new sparkle of diamonds. This abundance of diamonds led to the creation of some of the most inspired jewelry of all time.

Diamonds were discovered in Africa in 1867. The deposits were seemingly limitless. For the first time diamonds, the utmost of luxury goods, with a history of supreme rarity, could be afforded by the masses. Popular mercantile catalogues offered gold wedding bands for Victorian brides for as little as two pounds. For the first time she could hope for a diamond engagement ring to be offered to her as well.

DeBeers is perhaps the greatest cartel of the modern world. The origin of the company was also in the diamond rush of Africa. For over a hundred years it has built on the historic romantic perceptions of a diamond to spread its marketing wisdom over the world. In 1948, Frances Gerety, an employee of N.W. Ayer, was working on the DeBeers diamond campaign. She was inspired to write “A Diamond is Forever.” This is often cited as the most successful ad line of the twentieth century. The resulting campaign wed the concept of diamonds and love so succinctly that three years after its inception 80% of American brides were receiving diamond engagement rings.

The great addition to the history of jewelry in the twentieth century was the employment of platinum in jewelry. Platinum is extremely strong and durable. It allows designers to carve away and simplify the settings of jewelry to better show off the jewel they contained. The success of the classic “Tiffany-style” engagement mounting and the designs of Harry Winston are examples of this phenomenon. At the same time, an Antwerp diamond cutter named Marcel Tolkowsky scientifically developed the modem brilliant cut diamond. The interaction of angles in his cutting pattern greatly increased the brilliance, fire and dispersion in the gem. Together these factors thrust the diamond to the forefront, exclusive of its setting, as the symbol of romance and love. The evolution in the connotation of a diamond has reached the point whereby the ability of a diamond to convey a sense of love has become one of the most powerful and legitimate symbols of our time.

Roses and Love

In ancient Greece, Aphrodite, the goddess of Love, was clothed in garments comprised of roses. She claimed the flower, the most beautiful and coveted throughout the empire, as her symbol. At night Cupid slumbered on pillows of roses, and it was he who mischievously spilt the nectar of the gods on the rose to bequeath it with fragrance. “Garlandomania”, principally the crowning of lover's heads with roses, was a ritual that swept the land.

Roses are admired for their beauty—their color and form, for their perfume, and for their thorns and ephemerality. Roses symbolize love, beauty, youth, romance and sexual desire. Throughout much of history and many cultures roses have been the preeminent flower, perhaps achieved as their petals were relatively long lived, they were locally available in a wild form and they were passionately red and purely white. Romans so adored the flower that entire cites would be bedecked in masses of roses to celebrate the “marriage” of Venus. On this and other occasions lovers would grace the doors of their beloved in rose crowns. In Rome it was a bed of roses that epitomized the good life. Suetonius writes of a friend of Nero whose banquet required so many rose petals, at a cost of four million sesterces, that they had to be imported from Egypt and elsewhere to meet the demand. The path of the young, decadent Emperor Elagabalus was strewn with flowers and his beds were littered with roses and perfume. He instructed his servants to toss rose petals from oculi high over the banquet hall to descend upon his guests. Roses were cast in such profusion that some of the revelers met their death smothered in roses. The Roman festival for Floralia ushered the luxuriant goddess of flowers before prostitutes who undressed at the beckoning of the spectators. Decadence, fertility and sexuality ruled.

The rise of Christianity brought a decline to the rose that lasted a millenia. Flowers were decreed idolatrous and pagan; the rose above all others. The rose retained intrigue, but the voluptuousness of its past was deemed inappropriate and led to its suppression. Unsurprisingly, it was in centers of learning that some appreciation of flowers survived. At the court of Charlemagne in the early ninth century, the enjoyment of flowers was no longer limited to the permissible role of contemplation. Secular poems referred to flowers strewn in a lover's chamber, which was also scented with green herbs. When monasteries grew plants for food and medicine, roses were also grown and appreciated within their confines. The only record of a greenhouse in the Middle Ages refers to the Feast of the Epiphany given by the respected Dominican Albertus Magnus for Emperor William of Holland in 1249. The banquet Hall overflowed with pungent, flowering rosebushes and a multitude of trees bearing fruit. Guests attributed this midwinter display to magic.

The works of Abbott Suger, who conceived the first Gothic cathedral at St. Denis, reflected a grand shift in Christian teachings, whereby advancements in learning were pursued in the glory of Christ. The material rendered the immaterial explicable. The light and the glory of his cathedral's Rose Window illuminated this change. Gradually the restrictions on roses and similar symbols were lessened. Roses could be used for decoration, but not yet ornamentation—an important distinction. Roses appeared on the altar. The Virgin Mary was lovingly named “The Thornless Rose”.

The arrival of chivalry and contact with the flower rich East during the renascence of the twelfth century returned roses to the popular iconography of western civilization. As with Greece and Rome this rise was coupled with the growth of commerce and the ability of a society to afford divisions of labor and its attendant luxury goods. Starting with Germany in the tenth century a chaplet or chapeau of roses reappeared as a prominent note of beauty for the marriage ceremony. The roses brought color to the dances and served as opulent gifts for the guests. The poetics of the German Minnesaenger regales with the troubadour's tale of courtly love: of a knight who reclines in rose petalled water while a lady enters his chamber and offers him her chaplet of roses. In England roses are used for decoration beginning with the thirteenth century. Scribes note the proliferation of small gardens and rose petals are strewn about houses, streets and country lanes for weddings and other occasions of joy. In a prevalent romp known as the “Castle of Love”, young women protected the castle as knights besieged them with arrows of pelting roses.

During the Renaissance the rose remained the preeminent flower. Processions and pleasure gardens were marked by their presence. The early renaissance had admired the rose for its color and form. During the Renaissance its fragrance and sweetness was singled out for admiration. This led to a proliferation of beguiling perfumes during the Elizabethan period which were subsequently opposed by Puritans. Shakespeare refers to the rose fifty times, including “Of all the flowers, methinks the rose is best.” It was under the reign of Louis XIV that forced cultivation, forgotten since the Roman Empire, was again pursued on a grand scale. It was also during the 17th century that a bouquet of flowers eclipsed the flower crown and garland in Northern Europe as the floral preference. This heralded the Age of Great Flower paintings from the Netherlands.

In the Near East the rose was held in the highest esteem. The word for rose, “gul”, was used to describe all flowers. The rose and the nightingale were primary symbols of potent love. In medieval Islamic countries the representation of the rose was proscribed in accordance with religious tenets. This was not enforced to the extremes of European precedents, particularly in the realm of secular poetry. Persian poetry has a quality of striking tenderness. It was the poet Ha'fiz who first wrote of “pair of rosy lips”. He also wrote of being “Lured into a garden by the scent of roses to there find solace from the burn of unrequited love.”

A European cultural history of the nineteenth century would be incomplete without mention of the role that flowers played in society. This was the century that developed mass production of fresh flowers for the public. A literary phenomenon of 1819 termed “the Language of Flowers” is credited to Charlotte de Latour. She wrote “it is above all for those who know love . . . That we have brought together a few syllables of the language of flowers”. Within this language “a rose with its thorns and leaves means ‘I fear, but I am in hope’, if one turns the bud upside down that means: ‘One mustn't fear or hope’. Stripped of its thorn, the rose means ‘there is everything to hope for’, while stripped of its leaves it means there is everything to fear”. Scores of books by LaTour and others constituted a craze that continued throughout the century and revealed much about the rise of a middle class and the shifting relations between the sexes. The language of flowers had strong affiliation with pre-Raphaelite painters and their revival of chivalry and appreciation of women.

Of all the art forms it is primarily through literature that expressions of love are revealed by a rose. This may be due to the efficiency of the word to convey specific emotions. Dante and Chaucer wrote of the symbolism of flowers. The librettos of Mozart and Bizet profess of the rose's amorous charms. Whether as a high or low art form legions of love poems in every generation have affected popular sentiment. In the rose love had found its perfect metaphor. A typical example would be:

I send you a cream white rosebud

With a flush on its petal tips;

For the love that is purest and sweetest

Has a kiss of desire on the lips

A White Rose John Boyle O'Reilly

Roses convey love, sensuousness, life, youth and happiness. The rose's complicity also conveys their fleeting quality. Perhaps the most poignant aspect of the rose is ephemerality. Ernest Dowson succinctly describes this:

They aren't long the days of wine and roses!

Out of a misty dream,

our path emerges for a while,

then closes.

The essence of “rose” so permeates culture that Gertrude Stein was able to meaningfully pen “Rose is a rose is a rose is a rose”.

A Brief History of Diamond Synthesis

“To tell the truth, there is no fraud or deceit in the world which yields greater gain and profit than that of counterfeiting gems”. So wrote Pliny, one of history's great chroniclers (Book 37, Chapter 75), who met his death in the eruption of Vesuvius in 79 AD.

For centuries glass was the most successful counterfeiting material for any gems. Faceted coke bottles are still sold as emeralds in Columbia. However, glass did not suffice to fake a diamond, for throughout civilization what was known about diamonds is that they are incredibly hard. Practically speaking, what was known about diamonds is that they could cut glass. Indeed, Queen Elizabeth I and Sir Walter Raleigh used to exchange “love notes” by inscribing innuendoes with their diamond rings on window panes.

It is not surprising that John Baptista Porta wrote of how “To Turn a Saphire into a Diamond” in his Natural Magic of 1658. Next to diamond, sapphires and rubies are the hardest gem. By putting a sapphire in fire it would lose its color—in appearance it would then more closely approximate a diamond, particularly as diamonds were not yet faceted in a manner to maximize their extreme brilliance. The transforming properties of fire would make it more like a diamond; even if not a diamond. Certainly the gem would cut glass.

Another method developed to “make diamonds” that attempts to mimic their acclaimed invincibility is found in Secretos of Don Bernardo Monton, published in Madrid in 1760. He describes “A very noble secret to harden stones, to make them look like diamonds”:

In a retort you place alum crystals and distill them and then again put water on them three to four times, always distilling: then take this water and put it in a matras casserole with the carved crystal stones; put this over hot ashes and next under the casserole you place a burner of three or four wick for thirty days, everything in your oven being well regulated. (Translated by Kurt Nassau in Gemstone Enhancement)

At the end of the nineteenth century and the beginning of the twentieth century there were several noted attempts to create diamonds. In 1880 J. B. Hannay conducted 80 experiments whereby he heated paraffin, bone, oil and lithium metal in heavy iron tubing. This resulted in 77 explosions but yielded no diamonds. In 1886 F. H. Moissan, in 1906 W. Crookes and from 1890-1931 C. A. Parsons, conducted their own diamond synthesis experiments.

The most unusual of such attempts was conducted by an assistant of F. H. Moissan named Henri LeMoine in 1905. Lemoine was able to dupe DeBeers representatives into believing he could fabricate jewelry quality diamonds. To refute any claims that he might surreptitiously switch coal for diamonds he conducted his experiments for them in the nude. When his duplicity was finally made public at trial, all of Paris was chortling at the misled diamond leaders. Writers as noted as Marcel Proust were inspired to write of the scandal.

Genuine scientific breakthroughs are a great rarity. Such breakthroughs are generally based on the failed experiments of the past. When General Electric created its nine member “diamond” team in 1951 to develop a manner for actual diamond synthesis many industry leaders thought the pursuit foolish or impossible. On Feb. 15, 1955 GE held a meeting for the press to make the startling announcement that man had succeeded in creating diamonds. The results were not gem-like. They were microscopic and discolored. And the ghosts of alchemists looked humbly and admirably on.

In 1957 GE brought the first synthetic diamonds, “Type A”, to market for their industrial applications. In 1958 came the arrival of their Type B diamonds and in 1959 Type M diamonds, with numerous new products to consistently follow. In 1970 GE was known to produce a gem quality diamond. Its manufacture required over a week at a cost of approximately $20,000. Given such prohibitive costs the search for the production of gem quality synthetic diamonds was supposedly abandoned.

Richard Liddicoat wrote the lead editorial in the Winter 1986 issue of Gems & Gemology entitled “The Ultimate Synthetic: A Jewelry Quality Diamond”. He wrote, in part:

In 1985, Sumitomo Electric in Japan succeeded in the practical application of the G.E. Technology: the commercial production of cuttable synthetic diamonds. We are now looking at the very real prospect of readily available cuttable synthetic diamonds in sizes up to at least one-half carat. The researchers at Sumitomo have made great strides since the G.E. developments. Although they use the same principals, they have enlarged the size of the temperature-pressure chamber in which synthesis takes place from a capacity of one relatively small crystal to that of many crystals as large as 2 ct all growing at the same time. Whereas the growth of a single crystal over the relatively long period required had no hope of being economically viable, the production of many crystals during the same growth cycle makes possible a competitive picture . . . What is perhaps the last great barrier of gemology has been breached.

The synthesis of industrial grade diamond had proceeded markedly to the advent of the creation of synthetic gem grade diamond. This was achieved along all three of the primary areas of gem concern: carat weight, color and clarity. In 1986, the Gemological Institute of America had several of the Sumitomo diamonds faceted. They weighed only between 0.16 and 0.24 carats. They had significant metallic inclusions, so much so that some reacted to a magnet. They had a deep yellow color. On Jul. 10, 1990 GE Superabrasives announced that they had developed the first synthetic diamonds that were created with 99.9% carbon 12 isotopes. This breakthrough signaled a huge advance in the ability for the diamond to be the world's best conductors of heat, with substantial promise in the service of heat sinks in the computer industry. Of greater consequence to the jewelry trade, the diamonds were created in a highly desirable white E to G color range. DeBeers reaffirmed this discovery with their creation of near colorless to blue synthetic one carat diamonds in their Diamond Research Laboratory in Johannesburg. By the summer of 1992 it was reported that Sumitomo was producing synthetic yellow diamonds that weighed up to 9 carats. In 1993, another first, the GIA reported that their laboratory had been sent two faceted red diamonds of unknown origin. The two stones were determined to be synthetic diamonds that had undergone both irradiation and annealing to achieve their color. In addition to synthetic diamonds being manufactured in the United States and Japan, it was widely known that Russia was at the forefront of diamond synthesis, particularly in regards to fancy colored diamonds. In a more popular vein, in the mid-1990's, Life magazine ran a profile of a high school student who had succeeded in creating diamonds (albeit low pressure chemical vapor deposition diamonds) in her family's garage to submit for a science fair project.

In the last few years the most significant diamond synthesis related news concerned the announcement by the diamond manufacturer Lazare Kaplan that a high pressure high temperature (HPHT) treatment of diamonds that GE had researched for years allowed for the dramatic color improvement in off color, generally brown, diamonds.

On a final note, the first limited number of synthetic gem diamonds were offered for sale to the American public at an industry trade show in the summer of 1999. In 2002, an American firm succeeded in creating synthetic diamonds from the cremated remains of people and pets. In 2003, two other American companies announced plans to increase production capacities to market vast numbers of gem quality synthetic grade diamonds.

At this point, the method of fabrication of gem quality synthetic diamonds is well known in the art. The genius of the initial patents confirmed the possibility of the process. Many of the initial patents are held by a team of GE scientists often headed by Robert H. Wentorf Jr. Being an active field the potential has continued to progress from these origins.

Refinements to the process often focus on increasing the size of the reaction chamber —to accommodate the growth of larger crystals; the development of a more pure feedstock—to minimize metal inclusions, lead to regular crystal growth and increase the life of the synthesis equipment; or methods to vary the temperature gradient in the growth cell—to encourage the precipitation of diamond onto the seed crystal without dissolution of the diamond seed.

Despite this increasing manufacturing knowledge and cost reductions due to enhanced manufacturing techniques, synthetic diamonds are still not accepted as a substitute for natural diamonds or as a companion product. They are perceived as being less desirable than natural diamonds. Thus, there remains a need for a method of increasing consumer acceptance of such materials.

A company called LifeGems is promoting the creation of synthetic diamonds from the cremated remains of a loved one (see U.S. patent application 20030017932). While the wearing of a ring that contains this type of synthetic diamond may give comfort to some individuals, these products have not yet gained significant commercial acceptance, possibly due to the sacred nature of the material used to make the diamond. However, the present invention now resolves the problems and disadvantages of the prior art and provides synthetic diamonds that are desirably produced from much more acceptable carbon sources and which combine powerful symbolism of the love of the gift-giver toward the recipient.

### SUMMARY OF THE INVENTION

The present invention relates to a method of making a more permanent remembrance from a gift that includes organic material, wherein the gift has ephemeral beauty and symbolizes the feelings of a gift-giver toward a recipient. This method comprises transforming the ephemeral beauty of the gift to a more permanent or eternal manifestation that symbolizes the feelings of the gift-giver toward the recipient.

This result is conveniently achieved by converting the organic material of the gift to a synthetic diamond. The synthetic diamond can be prepared by transforming the organic material of the gift to a carbon or carbon-containing compound; and then converting the carbon or carbon-containing compound into the synthetic diamond. Advantageously, the carbon material is graphite and the carbon-containing compound is methane.

In one embodiment, the gift may be a proposed gift that is selected by the gift-giver but not given to the recipient. Instead, the gift-giver only bestows the diamond upon the recipient. In another embodiment, the gift is first given to the recipient and the organic material of the gift is later converted into the synthetic diamond that is bestowed upon the recipient. Of course, both the gift and the synthetic diamond symbolize the feelings of love from the gift-giver toward the recipient.

A preferred gift that includes organic material is a flower, and preferably a rose. The resulting “rose diamonds” can be of a selected color, including white, red, pink, yellow or blue or variations thereof as desired. It is preferred for the color of the synthetic diamond to represent the color of the rose. As natural fancy colored diamonds command a price premium, the synthetic versions of red and pink colors would have increased desirability.

The synthetic diamond is generally bestowed on the recipient to signify an important occasion. Such occasions include but are not limited to a proposal of marriage, an anniversary, a holiday, or the recipient's birthday.

### DETAILED DESCRIPTION OF THE PREFERRED EMBODIMENTS

In the following detailed description, the term “remembrance” is used to mean something that serves to keep in or bring to mind in a positive manner, as well as a greeting or gift recalling affection or friendship.

Also, the symbolism of roses and diamonds are synergistically and effectively combined in the synthetic diamonds of the present invention, which are termed “rose diamonds” in the most preferred embodiments.

Magicians, seers, doctors and scientists gazed into their respective philosopher's stones throughout the centuries in search of the manner to turn lead into gold. How much more beautiful to now be able to create diamonds from roses: “Rose Diamonds.” Diamond is elemental; it is pure carbon and carbon is the basis of all life. Roses, being of life, can in turn be reduced to carbon. By taking that carbon and coupling it with intense pressure and high heat, the process used for the synthesis of diamond, roses can be transmuted to diamond and made to endure a much greater time.

The history of the development of synthetic diamonds proceeds in increasing refinement. The original discovery dates to the laboratories of General Electric in 1954. The amazing, technical background is well documented in the art and is reviewed elsewhere. The process begins with the creation of industrial diamond material derived from methane or graphite, proceeds to small gem materials with poor color and extensive inclusions, to the present condition whereby large fine clean colored synthetic gem diamonds are now entering the market.

Absent from this litany of diamond synthesis discovery is a method to imbue the created diamond with the integral elements of love and romance. Their symbolic inclusion is central to diamond's allure and appeal. This crucial symbolism has been entirely lacking in the manufacture and perception of synthetic diamonds. Synthetic diamonds conjure up images of laboratories and test tubes. With great beauty and a sense of marvel the present invention of synthesizing diamonds with the carbon of rose ushers a striking fulfillment to the history of diamond synthesis. In this manner, synthetic diamonds will be true not only to its composition, method of “birth” and form—its natural history; but as importantly to its allure and mystique—its cultural history.

Diamonds and roses are the two pre-eminent symbols of love. Diamond's primary attribute of conveying love and romance will now be inextricably woven into the complete fabric of their creation. The ephemeral beauty of the rose is coupled with the eternal beauty of the diamond. The rose must wither, but may now bloom again as a diamond. Given that the raw material of manufacture comes from the natural and pure rose, an additional benefit to this process of synthesis is that the public will perceive it as “natural” versus the present perception of synthetic diamonds as industrial or engineered. The gift of a rose, given in the promise of love, is transformed to the eternal promise of love of a diamond. Organic becomes inorganic; blossom and petal become crystal.

In order to produce synthetic diamonds according to the present invention, it is first necessary to select a suitable gift that can be converted into a diamond by the processes disclosed herein. Preferably, the gift is made of an organic material that is capable of being converted to graphite. Suitable gifts include any kind of organic plant material, such as flowers, including roses, tulips, daffodils, carnations, chrysanthemums, lilies, and any others that can be given alone or in a bouquet. Due to their symbolism of love as detailed above, roses are preferred. While one type of flower can be used, it is also within the scope of this invention to combine flowers into bouquets of different flowers and use that material to create the graphite that is necessary to prepare diamonds according to the invention.

Other types of organic plant material can be used, if desired. Such materials include all types of plants, in the form of plants, bushes, or trees, as well as the fruits themselves, or any of a wide variety of vegetables or other edible plants. Of course, foods, particularly exotic foods, are gifts that have ephemeral beauty, and these can be converted to a more permanent form by conversion to diamonds. These types of organic plant materials are less preferred than flowers, but they are illustrative of the types of materials that can be converted according to the present invention. In contrast, it is understood that human or animal remains are not suitable types of organic plant materials that would be considered to be gifts.

As noted above, it is not necessary for the gift-giver to actually purchase and bestow the gift, i.e., the roses, on the recipient. Instead, it is more likely for the gift-giver to only give the rose diamond as a combined gift. It is the symbolism of the combined gift, i.e., that of the roses and the synthetic diamond, that is conveyed when only the synthetic diamond is bestowed upon the recipient. Of course, it is also within the scope of this invention for the gift-giver to first present the recipient with the gift, i.e., a bouquet of roses, and then at later date, to have the roses converted to a synthetic diamond.

The organic material of the gift is first converted into the necessary starting material to make the synthetic diamonds. While a form of carbon is required, solid forms such as graphite or gaseous forms such as methane can be used. The most preferred material is a carbon source that is obtained in an amorphous form that has been subjected to extensive graphitization.

Thereafter, the graphitized amorphous carbon is forwarded to the appropriate synthetic diamond forming equipment. A number of techniques utilizing different types of equipment are known, as evidenced by various patents that disclose techniques for preparing synthetic diamonds from a source of carbon. These include U.S. Pat. Nos. 6,270,548, 5,908,503 and 5,503,104. To the extent necessary, the entire contents of these patents are incorporated herein by reference thereto.

A brief synopsis of the preferred technique for synthetic diamond synthesis as it applies to the present invention is described as follows.

The method of the present invention includes the steps of loading a growth cell with polycrystalline CVD diamonds, suitable catalyst, and the source of graphitized amorphous carbon. Then, pressure and heat are applied to the loaded cell in such a way as to induce a temperature gradient across the growth cell. Pressures and temperatures throughout the growth cell are such that diamond is the thermodynamically stable form of carbon.

The article of the present invention is produced in a growth cell whose size and shape is defined by the apparatus that supplies the high pressure to the materials contained in the growth cell. The high pressure apparatus is any piece of equipment capable of inducing the necessary pressures to sustain diamond formation within the enclosed growth cell. It can include equipment used in the prior art method of high pressure diamond gem manufacture. Such an apparatus is capable of withstanding high pressures and high temperatures. This equipment is well known in the art. A typical apparatus is described in U.S. Pat. No. 3,297,407, which is also incorporated herein by reference. Briefly, this apparatus includes an annular belt member having a convergent divergent aperture therethrough. A pair of frustoconical oppositely positioned and movable punches move into the opening to define a reaction chamber. A growth cell, containing specimen material, is placed in the reaction chamber and compression thereof through motion of the frustoconical punches subjects the sample material to high pressures. Many variation of such apparatuses have been disclosed. They include multi-piece dies with gaskets between individual segments, such as is described in U.S. Pat. Nos. 2,941,244 and 2,947,034, which are also incorporated herein by reference. Other types of apparatuses include a given closed reaction chamber that is defined by a plurality of interfitting overlapping pressure resisting members all of which are in a sliding relationship. The arrangement provides a reduction in volume of the growth cell along more than two axes. Such an apparatus is detailed in U.S. Pat. No. 3,271,502 which also is incorporated herein by reference.

Pressures within the growth cell typically range from about 5-7 Gpa. The temperature is typically maintained at about 1300-1800 degrees Celsius. Heat can be supplied by any method known in the art, for example, electrical resistance heating can be employed to attain necessary temperatures. It is important that the heat be applied in such a manner as to produce a temperature gradient within the growth cell so that the growth cell is hottest at the carbon source and coolest at the polycrystalline CVD diamond. In this way, the metallic solvent is saturated with carbon when in contact with the carbon source and is supersaturated with carbon when in contact with the polycrystalline CVD diamond. There is, therefore, a driving force to dissolve, transport and redeposit diamond from the carbon source and onto the polycrystalline CVD diamond. Polycrystalline CVD diamond is well known in the art. CVD diamond can be produced by various methods including, but not limited to, DC plasma, microwave plasma, and hot filament CVD techniques. For use in the present invention the method of producing the polycrystalline CVD diamond is not critical. Typically, a plate or disc of polycrystalline CVD diamond will be place in the growth cell.

Suitable catalysts for high pressure diamond growth are well known in the art. They include metals such as iron, aluminum, nickel, cobalt, tantalum, manganese, chromium and alloys thereof.

Diamond growth is provided by dissolving diamond or carbon in molten catalyst and then precipitating diamond from the molten catalyst on to the polycrystalline CVD diamond. For the present invention, the carbon source necessary is an amorphous carbon that has undergone extensive graphitization.

The synthetic diamond that is produced can be made in various colors. Unlike natural diamonds that are most often clear or white, synthetic diamonds can be produced in white as well as colors such as yellow, pink, blue and red. Variations in these colors can also be achieved, if desired. The skilled artisan who is familiar with the technology for creating synthetic diamonds is well aware of the process modifications that can be implemented to achieve the desired color (including white). For example, it is conventional to add dopants to graphite powder, or to anneal white synthetic diamonds to impart colors other than white. As noted above, this invention allows the gift-giver to select the color of the diamond based on the color of the flower or roses that was contemplated as the gift. This creates a more complete remembrance of the gift that can be enjoyed for a much longer time than the flower.

The invention also contemplates a person purchasing one of the synthetic diamonds described herein for their own use. In this embodiment, the gift-giver and the recipient would be the same person.

Also, the synthetic diamond may be bestowed upon a recipient as an award or prize. For example, entertainment awards are often made of precious metals and gems, and it is entirely possible for the synthetic diamonds of the present invention to be incorporated in such awards. Also, contemplated by the invention is the situation where the gift is conditional or the diamond is set in jewelry that is loaned or borrowed from the owner. This is typically done in the entertainment industry where jewelry designers loan their creations to recognized actors for the promotion of their designs. These situations are also contemplated by the terms “gift-giver” and “recipient” in this invention.

The synthetic diamond can be mounted or incorporated in any type of jewelry in the same manner as natural diamonds. Thus, a wide variety of rings, earrings, necklaces, pendants, bracelets and the like can be made using the synthetic diamonds of the invention. Of course, the skilled artisan can envision many modifications and alternative embodiments of the invention, and it is intended that all such embodiments be encompassed by the appended claims.

What is claimed is:

1. A method of making a more permanent remembrance from a gift that includes organic material, wherein the gift has ephemeral beauty and symbolizes the feelings of a gift-giver toward a recipient, which method comprises transforming the ephemeral beauty of the gift to a more permanent or eternal manifestation that symbolizes the feelings of the gift-giver toward the recipient by converting the organic material of the gift to a synthetic diamond.

2. The method of claim 1, wherein the synthetic diamond is prepared by transforming the organic material of the gift to a carbon or carbon-containing compound; and converting the carbon or carbon-containing compound into the synthetic diamond.

3. The method of claim 2, wherein the carbon material is graphite and the carbon-containing compound is methane.

4. The method of claim 2, wherein the organic material comprises organic plant material.

5. The method of claim 4, wherein the organic plant material is an edible or non-edible plant, bush, or tree or a fruit or vegetable produced thereby.

6. The method of claim 5, wherein the organic plant material is a flower.

7. The method of claim 6, wherein the flower is a rose.

8. The method of claim 1, wherein the gift is a proposed gift and only the diamond is bestowed upon the recipient.

9. The method of claim 1, wherein the gift is first given to the recipient and the organic material of the gift is later converted into the synthetic diamond.

10. The method of claim 1, wherein both the gift and the synthetic diamond symbolize feelings of love from the gift-giver toward the recipient.

11. The method of claim 1, wherein the synthetic diamond has a white, red, pink, yellow or blue color.

12. The method of claim 1, which further comprises bestowing the synthetic diamond on the recipient to signify an important occasion.

13. The method of claim 12, wherein the occasion is a proposal of marriage, an anniversary, a holiday, or the recipient's birthday.

14. The method of claim 1, wherein the gift-giver and the recipient are the same person.

15. A method of making a more permanent remembrance from a gift of organic plant material having ephemeral beauty and that symbolizes the feelings of a gift-giver toward a recipient, which method comprises transforming the ephemeral beauty of the organic plant material to a more permanent or eternal manifestation of such beauty as well as the feelings of the gift-giver toward the recipient by converting the organic plant material to a synthetic diamond.

16. The method of claim 15, wherein the organic plant material is an edible or non-edible plant, bush, or tree or a fruit or vegetable produced thereby.

17. A method of making a more permanent remembrance from a gift of a flower or flowers having ephemeral beauty and that symbolizes the feelings of a gift-giver toward a recipient, which method comprises transforming the ephemeral beauty of the flower(s) to a more permanent or eternal manifestation of such beauty as well as the feelings of the gift-giver toward the recipient by converting the flower(s) to a synthetic diamond.

18. The method of claim 17 wherein the synthetic diamond is prepared by transforming organic material of the flower(s) to a carbon or carbon-containing compound; and converting the carbon or carbon-containing compound into the synthetic diamond.

19. The method of claim 17, wherein the synthetic diamond has a white, red, pink, yellow or blue color which represents the color of the flower(s).

20. The method of claim 19 wherein the flower(s) comprises rose(s).
